(19) United States
(12) Patent Application Publication
(10) Pub. No.: US 2026/0249616 A1
(43) Pub. Date: Aug. 27, 2026

(54) LIQUID EJECTING HEAD AND LIQUID EJECTING APPARATUS

(71) Applicant: SEIKO EPSON CORPORATION, Tokyo (JP)

(72) Inventors: Takahiro KANEGAE, SHIOJIRI-SHI (JP); Yu SHIOZAWA, MINAMIMINOWA-MURA (JP); Yoichi NAGANUMA, MATSUMOTO-SHI (JP); Satoko UEKAWA, SHIOJIRI-SHI (JP)

(21) Appl. No.: 19/548,155

(22) Filed: Feb. 24, 2026

(30) Foreign Application Priority Data
Feb. 27, 2025 (JP) 2025-030798

(51) Int. Cl. B41J 2/19; B41J 2/14; B41J 2/18

(52) U.S. Cl. CPC B41J 2/19; B41J 2/14233; B41J 2/1433; B41J 2/18; B41J 2002/14419; B41J 2002/14491; B41J 2202/07; B41J 2202/12

(57) ABSTRACT

A liquid ejecting head includes a nozzle, a pressure chamber communicating with the nozzle, a communication path connected to the pressure chamber and connected to the nozzle, a supply path that supplies a liquid to the pressure chamber, and a collection path that communicates with the communication path and collects the liquid from the communication path, the supply path, the pressure chamber and the communication path, and the collection path are, in plan view as viewed in an ejection direction, arranged in this order in a first direction, the communication path is defined by a first surface disposed between the nozzle and the collection path, the first surface being an inclined surface or a curved surface that extends in a second direction opposite to the ejection direction while extending toward the first direction, and the collection path is connected to the communication path so as to be adjacent to the first surface.

The present application is based on, and claims priority from JP Application Serial Number 2025-030798, filed Feb. 27, 2025, the disclosure of which is hereby incorporated by reference herein in its entirety.

### BACKGROUND

### 1. Technical Field

The present disclosure relates to a liquid ejecting head that ejects a liquid from a nozzle and a liquid ejecting apparatus, and particularly to an ink jet recording head that ejects an ink as a liquid and an ink jet recording apparatus.

### 2. Related Art

The liquid ejecting head includes a nozzle, a pressure chamber communicating with the nozzle, and a driving element that causes a pressure change in a liquid in the pressure chamber, and ejects liquid droplets from the nozzle by the pressure change in the liquid in the pressure chamber by the driving of the driving element.

In the pressure chamber of such a liquid ejecting head, air bubbles may enter from the nozzle or a supply path that supplies the liquid to the pressure chamber, and if the air bubbles are present in the pressure chamber, the air bubbles absorb the pressure change in the pressure chamber, and ejection failure occurs. For this reason, there is disclosed a configuration in which a supply path that supplies a liquid to a pressure chamber and a discharge path that discharges the liquid in the pressure chamber are provided, and air bubbles in the pressure chamber are discharged from the discharge path (for example, see JP-A-2023-105351).

However, in the configuration disclosed in JP-A-2023-105351, when air bubbles entering from the supply path or the nozzle enter a communication path that communicates the pressure chamber and the nozzle, and the air bubbles in the communication path rise into the pressure chamber due to the buoyancy, it is necessary to cause the air bubbles to flow from the pressure chamber to the discharge path against the buoyancy in order to discharge the air bubbles in the pressure chamber to the discharge path, which creates a problem in that the air bubbles are difficult to discharge.

### SUMMARY

An aspect of the present disclosure for solving the above-described problem is a liquid ejecting head including a nozzle that ejects a liquid in an ejection direction, a pressure chamber that communicates with the nozzle and applies a pressure to the liquid, a communication path connected to the pressure chamber in the ejection direction and connected to the nozzle, a supply path that communicates with the pressure chamber and supplies the liquid to the pressure chamber, and a collection path that communicates with the communication path and collects the liquid from the communication path, wherein the supply path, the pressure chamber and the communication path, and the collection path are, in plan view as viewed in the ejection direction, arranged in this order in a first direction, the communication path is defined by a first surface disposed between the nozzle and the collection path, the first surface being an inclined surface or a curved surface that extends in a second direction opposite to the ejection direction while extending toward the first direction, and the collection path is connected to the communication path so as to be adjacent to the first surface.

Another aspect of the present disclosure is a liquid ejecting apparatus including the liquid ejecting head according to the above-described aspect, and a liquid storage portion that supplies a liquid to the liquid ejecting head.

### BRIEF DESCRIPTION OF THE DRAWINGS

FIG. 1 is an exploded perspective view of a liquid ejecting head according to a first embodiment.

FIG. 2 is a plan view of a pressure chamber substrate and a communication plate according to the first embodiment.

FIG. 3 is a sectional view of the liquid ejecting head according to the first embodiment.

FIG. 4 is an enlarged sectional view of a main portion of the liquid ejecting head according to the first embodiment.

FIG. 5 is a perspective view of a main portion of the communication plate according to the first embodiment.

FIG. 6 is a plan view of a first surface according to the first embodiment.

FIG. 7 is a perspective view of a main portion of the communication plate showing a modification of a collection path according to the first embodiment.

FIG. 8 is a plan view of the first surface showing the modification of the collection path according to the first embodiment.

FIG. 9 is a sectional view of a main portion of a liquid ejecting head according to a second embodiment.

FIG. 10 is a plan view of a pressure chamber substrate and a communication plate according to the second embodiment.

FIG. 11 is a view showing a schematic configuration of a liquid ejecting apparatus according to an embodiment.

### DESCRIPTION OF EMBODIMENTS

The present disclosure will be described in detail below based on embodiments. However, the following description merely shows an aspect of the present disclosure, and can be appropriately changed within the scope of the present disclosure. In the drawings, the same reference numerals denote the same members, and the description thereof will be appropriately omitted. In each drawing, X, Y, and Z represent three spatial axes that are orthogonal to each other. In the present specification, directions along these axes are referred to as an X direction, a Y direction, and a Z direction. In each drawing, a direction indicated by an arrow is a positive (+) direction, and a direction opposite to the arrow is a negative (−) direction. The Z direction indicates a vertical direction, a +Z direction indicates a vertically downward direction, and a-Z direction indicates a vertically upward direction. Furthermore, the directions of the three spatial axes, which are not limited to the positive direction or the negative direction, will be described as an X-axis direction, a Y-axis direction, and a Z-axis direction.

### First Embodiment

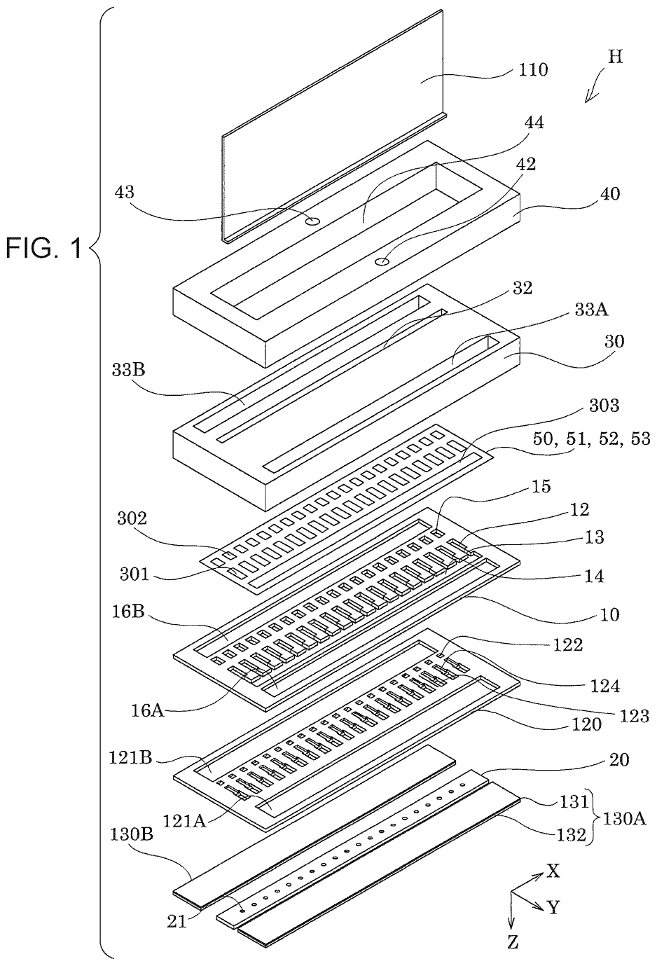

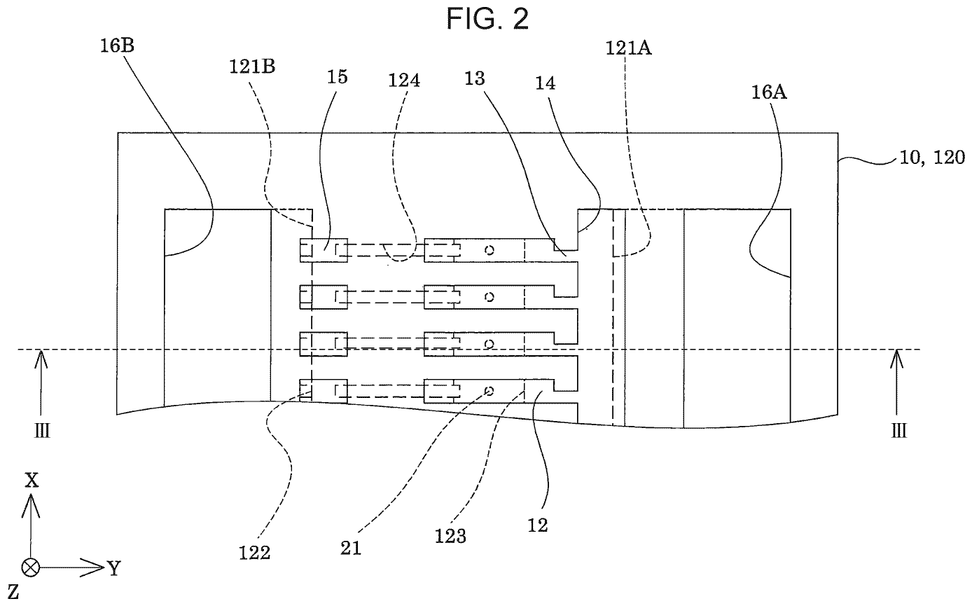

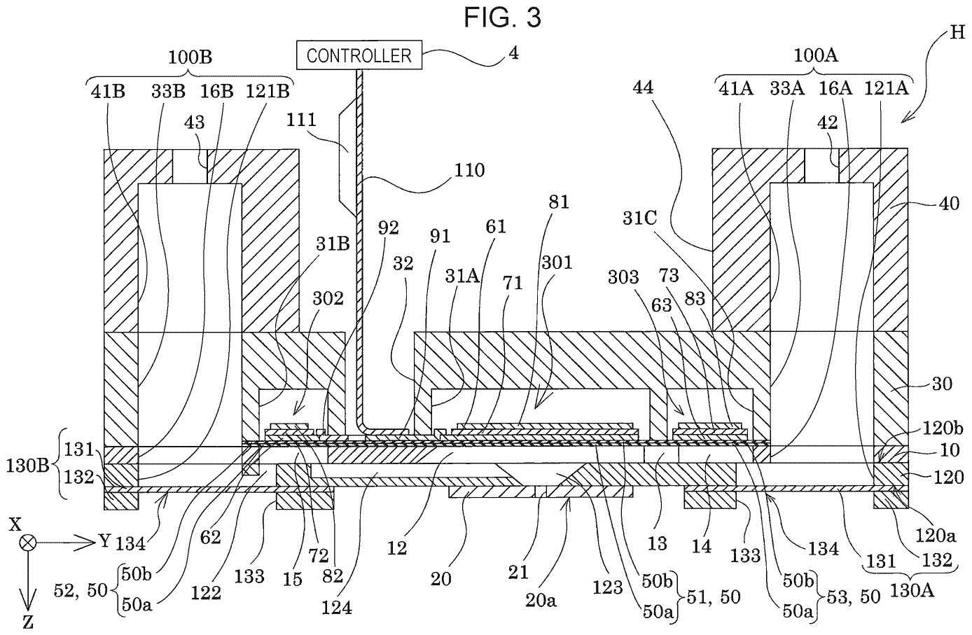

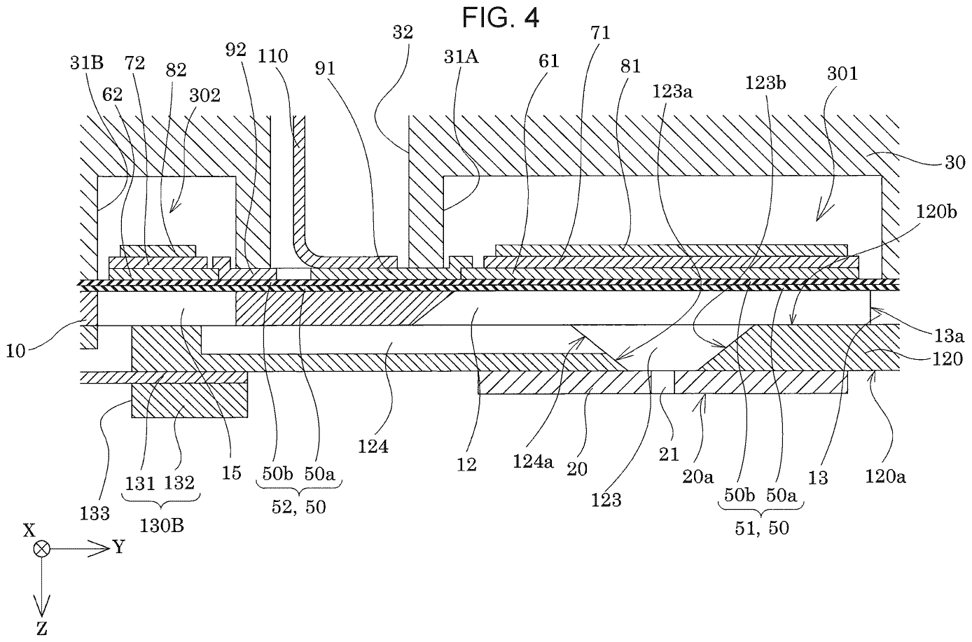

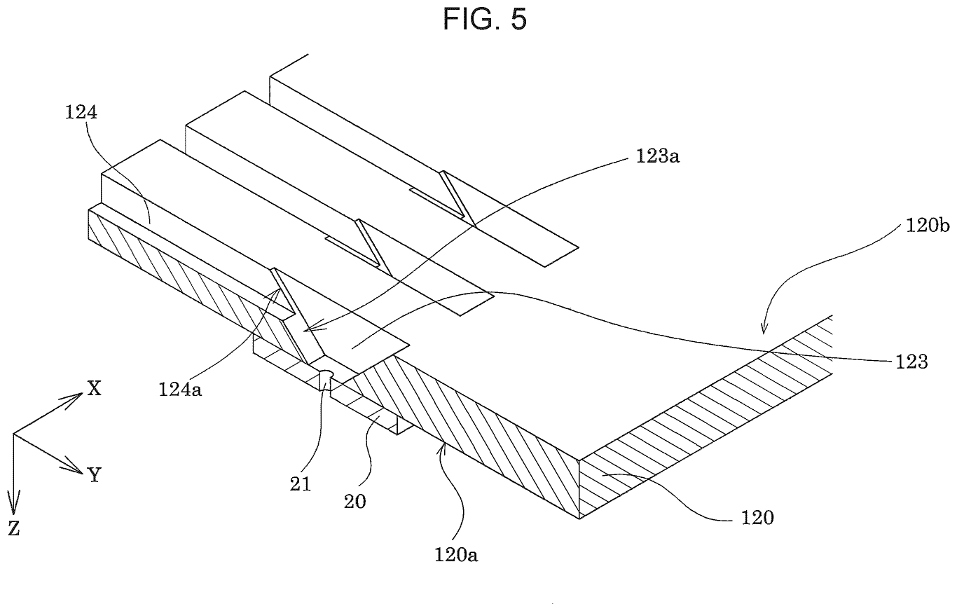

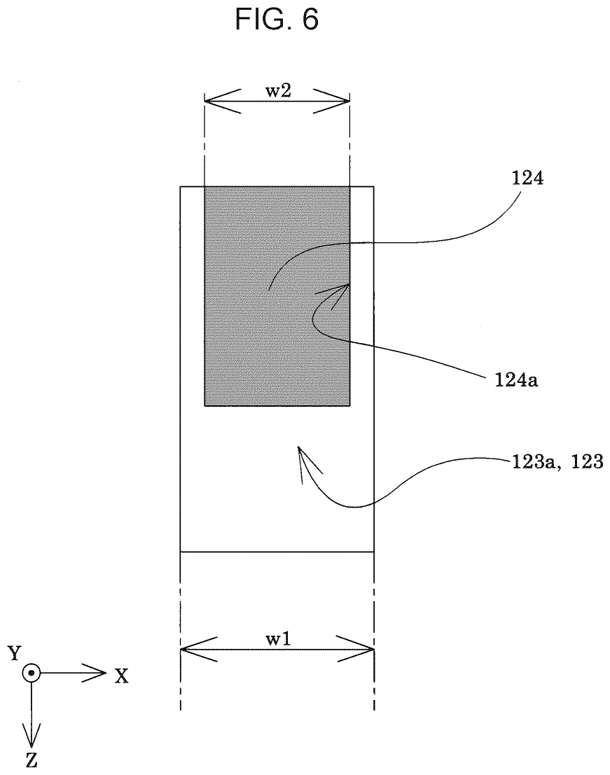

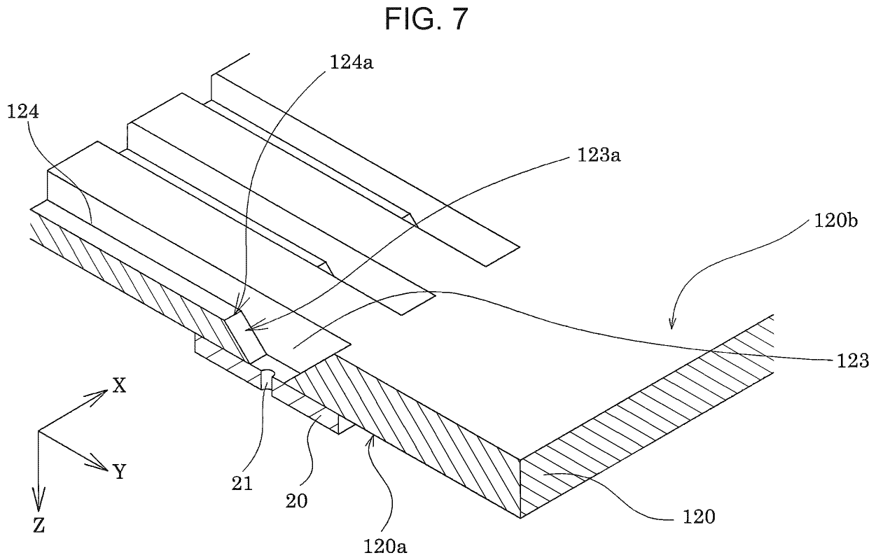

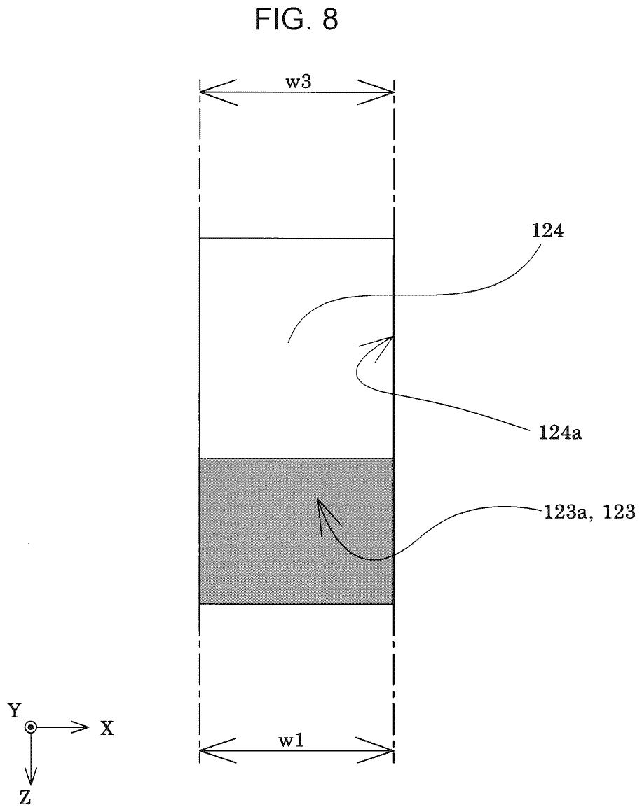

FIG. 1 is an exploded perspective view of a liquid ejecting head H according to a first embodiment of the present disclosure. FIG. 2 is a plan view of a pressure chamber substrate 10 and a communication plate 120 as viewed in the +Z direction. FIG. 3 is a sectional view of the liquid ejecting head H taken along line III-III of FIG. 2. FIG. 4 is an enlarged view of a main portion of FIG. 3. FIG. 5 is a cutaway perspective view of main portions of the communication plate 120 and a nozzle plate 20. FIG. 6 is a plan view of a first surface 123a of FIG. 5 as viewed in a −Y direction. FIG. 7 is a cutaway perspective view of the main portions of the communication plate 120 and the nozzle plate 20, showing a modification of a collection path 124. FIG. 8 is a plan view of the first surface 123a of FIG. 7 as viewed in the −Y direction. In FIGS. 6 and 8, the first surface 123a is shown in gray scale.

The liquid ejecting head H is configured as a head for ejecting an ink in a printer. The ink is guided to the liquid ejecting head H, and a part of the ink is ejected from nozzles 21 toward the outside, for example, a print medium. Since the ink is circulated, a part of the ink which is not ejected from the nozzles 21 is discharged from the liquid ejecting head H. Therefore, in the present specification, the terms “supply side” and “discharge side” may be used. The “supply side” indicates an upstream of pressure chambers which will be described later with respect to flow paths of a liquid. In addition, a component related to the upstream of the pressure chambers may be referred to as the “supply side”. The “discharge side” indicates a downstream of pressure chambers 12 with respect to the flow paths of the liquid. The “discharge side” does not include the nozzles 21 which will be described later. In addition, a component related to the downstream of the pressure chambers 12 may be referred to as the “discharge side”. The liquid is not limited to ink, and the liquid ejecting head H can be configured to eject other liquids.

As shown, the liquid ejecting head H includes the nozzle plate 20, the communication plate 120, the pressure chamber substrate 10, a protective substrate 30, and a case 40 in order toward the −Z direction.

The pressure chamber substrate 10 is formed of, for example, a silicon substrate, a glass substrate, an SOI substrate, or any kind of ceramic substrates.

In the pressure chamber substrate 10, a plurality of pressure chambers 12 are arranged side by side in the X-axis direction. The plurality of pressure chambers 12 are arranged on a straight line in the X-axis direction so as to be at the same position with respect to the Y-axis direction. Two pressure chambers 12 adjacent to each other in the X-axis direction are partitioned by a partition wall. Each of the plurality of pressure chambers 12 is defined by a through hole passing through the pressure chamber substrate 10 in the Z-axis direction from a surface in the −Z direction to a surface in the +Z direction of the pressure chamber substrate 10. Here, the “through hole” refers to a space defined by side surfaces which connect a surface facing the −Z direction to a surface facing the +Z direction of the pressure chamber substrate 10. The side surfaces may be surfaces inclined with respect to the Z-axis direction, that is, the through hole may be defined by inclined surfaces.

In addition, the pressure chamber substrate 10 includes ink supply paths 13, each of which communicates with one end portion side of the pressure chamber 12 in a +Y direction for each pressure chamber 12. The ink supply path 13 is defined by a through hole passing through the pressure chamber substrate 10 in the Z direction, is formed to have a width narrower than that of the pressure chamber 12 in the X-axis direction, and maintains a constant flow path resistance of the ink which flows into the pressure chamber 12 from the upstream. That is, the ink supply path 13 functions as a so-called throttle portion. The ink supply path 13 is not limited to the configuration in which the width in the X-axis direction is narrowed, and the height in the Z-axis direction may be narrowed. In addition, the pressure chamber 12 refers to an area up to a connection port connected to the ink supply path 13. In addition, the surface of the pressure chamber 12 and the ink supply path 13 in the −Z direction are defined by a first diaphragm 51.

In addition, the pressure chamber substrate 10 includes an absorption chamber 14 communicating with the other end portion opposite to the one end portion of the ink supply path 13 communicating with the pressure chamber 12 in the Y-axis direction, that is, an end portion in the +Y direction. The absorption chamber 14 is defined by a through hole passing through the pressure chamber substrate 10 in the Z-axis direction. That is, the pressure chamber 12 and the absorption chamber 14 communicate with each other via the ink supply path 13. The absorption chamber 14 is provided continuously in the X-axis direction over a plurality of ink supply paths 13. A surface of the absorption chamber 14 in the −Z direction is defined by a third diaphragm 53. Such an absorption chamber 14 functions as a damper for absorbing the vibration of the ink. Note that the absorption chamber 14 is not necessarily required, and the absorption chamber 14 need not be provided.

In addition, the pressure chamber substrate 10 includes detection chambers 15, which are located in the −Y direction opposite to the ink supply paths 13 with respect to the pressure chambers 12 in the Y-axis direction, and are separated from the pressure chambers 12 in the Y-axis direction. Each of the detection chambers 15 is defined as a through hole passing through the pressure chamber substrate 10 in the Z-axis direction. A plurality of detection chambers 15 are arranged side by side in the X-axis direction. That is, the plurality of detection chambers 15 are arranged on a straight line in the X-axis direction so as to be at the same position with respect to the Y-axis direction. Two detection chambers 15 adjacent to each other in the X-axis direction are partitioned by a partition wall. In the present embodiment, each of the detection chambers 15 has the same width as a width of each of the pressure chambers 12 in the X-axis direction, and the detection chambers 15 are arranged at the same pitch as a pitch of the pressure chambers 12 in the X-axis direction. In addition, the detection chamber 15 is provided to have a length shorter than a length of the pressure chamber 12 in the Y-axis direction. Incidentally, the width and the length of the pressure chamber 12 and the detection chamber 15 are dimensions in surfaces defined by a diaphragm 50, that is, surfaces in the -Z direction. In addition, the surface of the detection chamber 15 in the −Z direction is defined by a second diaphragm 52. Note that the detection chambers 15 are not necessarily required, and the detection chambers 15 need not be provided.

In the pressure chamber substrate 10, on both end portions in the Y-axis direction, that is, on both outer sides of the pressure chambers 12, the absorption chamber 14, and the detection chambers 15, flow paths 16A and 16B constituting parts of common liquid chambers 100A and 100B, respectively are formed, and the plurality of pressure chambers 12 communicate with the flow paths 16A and 16B in common. In the present embodiment, the supply-side common liquid chamber 100A and the discharge-side common liquid chamber 100B are formed in the liquid ejecting head H, and the flow path 16A constituting a part of the supply-side common liquid chamber 100A and the flow path 16B constituting a part of the discharge-side common liquid chamber 100B are provided in the pressure chamber substrate 10. These flow paths 16A and 16B are provided to pass through the pressure chamber substrate 10 in the Z-axis direction.

The communication plate 120 and the nozzle plate 20 are sequentially stacked on the surface of the pressure chamber substrate 10 facing the +Z direction.

The communication plate 120 includes a flow path 121A constituting a part of the common liquid chamber 100A and a flow path 121B constituting a part of the common liquid chamber 100B. The flow path 121A is a flow path constituting a part of the supply-side common liquid chamber 100A, and is provided to pass through the communication plate 120 in the Z-axis direction at a position overlapping the flow path 16A of the pressure chamber substrate 10 when viewed in the Z-axis direction. In addition, the flow path 121A extends in the −Y direction to a position overlapping an end portion of the absorption chamber 14 in the +Y direction when viewed in the Z-axis direction. Accordingly, the flow path 121A communicates with the absorption chamber 14 of the pressure chamber substrate 10 in the Z-axis direction at the end portion in the −Y direction. In addition, the flow path 121B is a flow path constituting a part of the discharge-side common liquid chamber 100B, and is provided to pass through the communication plate 120 in the Z-axis direction at a position overlapping the flow path 16B of the pressure chamber substrate 10 when viewed in the Z-axis direction. In addition, the flow path 121B extends in the +Y direction to a position overlapping end portions of the detection chambers 15 in the −Y direction when viewed in the Z-axis direction. A portion of the flow path 121B, which extends in the +Y direction does not pass through the communication plate 120 in the Z-axis direction, and has a recessed shape which is open on a surface facing the +Z direction.

In addition, the communication plate 120 is provided with discharge communication paths 122 through which the detection chambers and the flow path 121B communicate with each other, and the ink in the detection chambers is discharged to the flow path 121B via the discharge communication paths 122. In the present embodiment, the absorption chamber 14, the ink supply paths 13, and the supply-side common liquid chamber 100A function as “supply paths” that supply the ink to the pressure chambers 12.

In addition, the communication plate 120 includes communication paths 123 through which each of the pressure chambers 12 and each of the nozzles 21 individually communicate with each other, and collection paths 124 that collect the ink in the communication paths 123 and the pressure chambers 12 to the outside of the liquid ejecting head H.

Each of the communication paths 123 is defined by a through hole passing through the communication plate 120 in the Z-axis direction. For this reason, an end portion of the communication path 123 in the −Z direction communicates with the pressure chamber 12, and an end portion of the communication path 123 in the +Z direction communicates with the nozzle 21. Specifically, in the present embodiment, the “through hole” refers to a space defined by a side surface in the communication plate 120 which extends from a surface 120a facing the +Z direction to a surface 120b facing the −Z direction of the communication plate 120, and a virtual surface which partially includes a side surface extending from the surface 120a toward the surface 120b of the communication plate 120 and extends from the surface 120a to the surface 120b along the side surface. That is, the side surfaces extending from the surface 120a toward the surface 120b of the communication plate 120 are the first surface 123a and a second surface 123b described below, and a connection port 124a is open on the virtual surface. Each of a plurality of such communication paths 123 is provided independently for each of the pressure chambers 12, that is, independently in the X-axis direction.

Both sides of the communication path 123 in the Y-axis direction are defined by the first surface 123a and the second surface 123b. Here, the first surface 123a defines a side surface of the communication path 123 in the −Y direction, and is disposed between each of the nozzles 21 and each of the collection paths 124 in the Y-axis direction. In addition, the first surface 123a is an inclined surface which is inclined in the −Z direction while extending toward the −Y direction. The second surface 123b defines a side surface on a +Y direction side of the communication path 123 with respect to the first surface 123a, and is disposed between the nozzle 21 and the pressure chamber 12. In addition, the second surface 123b is an inclined surface which is inclined in the +Z direction while extending toward the −Y direction. The “inclined surface” in the present specification refers to a flat surface which is inclined with respect to an XY plane and an XZ plane and is other than a surface along a YZ plane.

The collection path 124 is defined by a recessed portion, the recessed portion being recessed in the +Z direction from the surface 120b of the communication plate 120 facing the −Z direction and being connected to the communication path 123. The “recessed portion” in the present specification refers to a space which is open on one surface of the substrate and is not open on the other surface opposite to the one surface, that is, a space provided in a part of the thickness without passing through the substrate in the thickness direction. The collection path 124 of the present embodiment is open on the surface 120b of the communication plate 120 facing the −Z direction and is not open on the surface 120a of the communication plate 120 facing the +Z direction, that is, the collection path 124 is provided in a part of the thickness in the Z-axis direction without passing through the communication plate 120 in the Z-axis direction. For this reason, the recessed portion that forms the collection path 124 is not open on the surface 120a of the communication plate 120 facing the +Z direction. That is, the collection path 124 is not defined by the nozzle plate 20 fixed to the surface of the communication plate 120 in the +Z direction. Each of the plurality of such collection paths 124 is provided independently for each of the pressure chambers 12, that is, independently in the X-axis direction. In addition, the collection path 124 extends in the −Y direction from the connection port 124a through which the collection path 124 is connected to the communication path 123. That is, when viewed in the +Z direction, the absorption chamber 14 and the ink supply path 13 that constitute the supply path, the pressure chamber 12 and the communication path 123, and the collection path 124 are arranged side by side in the −Y direction.

One end of such a collection path 124 in the +Y direction communicates with the communication path 123, and the other end of the collection path 124 in the −Y direction extends to a position overlapping an end portion of the detection chamber 15 in the +Y direction when viewed in the Z-axis direction. In addition, the one end of the collection path 124 is connected to the communication path 123 so as to be adjacent to the first surface 123a. Here, the one end of the collection path 124 being adjacent to the first surface 123a means that the collection path 124 is directly connected to the communication path 123 so as to be open on the first surface 123a of the communication path 123. That is, at least a part of an opening edge portion of the first surface 123a is present on the first surface 123a. That is, an inner surface defining the collection path 124 and the first surface 123a defining the communication path 123 are directly connected to each other without another surface interposed therebetween.

In addition, as shown in FIGS. 5 and 6, the collection path 124 of the present embodiment has a width w2 in the X-axis direction of the connection port 124a connected to the communication path 123, and the width w2 is smaller than a width w1 in the X-axis direction of the communication path 123. By making the width w2 in the X-axis direction of the collection path 124 smaller than the width w1 of the communication path 123 in this way, it is possible to make the flow path sectional area of the collection path 124 smaller, it is possible to increase the flow velocity of the ink flowing in the collection path 124, and it is possible to easily discharge the air bubbles in the collection path 124 to the outside from the collection path 124.

Of course, as shown in FIGS. 7 and 8, the collection path 124 may have a width w3 in the X-axis direction of the connection port 124a connected to the communication path 123, and the width w3 may have the same size as the width w1 in the X-axis direction of the communication path 123. By making the size of the width w3 in the X-axis direction of the collection path 124 the same as the size of the width w1 of the communication path 123 in this way, a step due to the difference in width is not formed at a connecting portion connecting the communication path 123 and the collection path 124, and the occurrence of the discharge failure of the air bubbles due to the air bubbles being caught in the step can be suppressed.

Both sides of the communication path 123 in the X-axis direction are defined by partition walls, and a surface in the +Z direction is defined by the nozzle plate 20.

In addition, at least a part of the connection port 124a through which the collection path 124 is connected to the communication path 123 is disposed further in the +Z direction than a connection port 13a through which the ink supply path 13 communicates with the pressure chamber 12. That is, the connection port 124a through which the collection path 124 is connected to the communication path 123 is located within the range of a thickness direction of the communication plate 120 in the Z-axis direction, whereas the connection port 13a through which the ink supply path 13 is connected to the pressure chamber 12 is located within the range of a thickness direction of the pressure chamber substrate 10 in the Z-axis direction. In this way, by disposing the connection port 124a through which the collection path 124 is connected to the communication path 123 further in the +Z direction than the connection port 13a through which the ink supply path 13 is connected to the pressure chamber 12, the air bubbles in the communication path 123 are easily directed to the collection path 124 ahead of the ink supply path 13, and it is possible to improve the air-bubble discharging performance by the collection path 124 and to suppress the entry of the air bubbles into the ink supply path 13 from the communication path 123. In addition, since the ink flows from the ink supply path 13 to the collection path 124 toward the lower left in FIG. 4, that is, toward a direction including components of the −Y direction and the +Z direction, it is possible to make it difficult for the air bubbles in the communication path 123 to move toward the −Z direction. That is, although the air bubbles tend to move in the −Z direction due to the buoyancy, since the ink flowing from the ink supply path 13 to the collection path 124 toward the lower left in the drawing is formed, the movement of the air bubbles in the −Z direction due to the buoyancy is suppressed. Therefore, the air bubbles in the communication path 123 can be easily discharged by the collection path 124.

The collection path 124 is disposed at a position overlapping the pressure chamber 12 when viewed in the +Z direction, and the collection path 124 is connected to the pressure chamber 12 in a region overlapping the pressure chamber 12. That is, since the collection path 124 is provided to be open on the surface 120b of the communication plate 120 facing the −Z direction and the pressure chamber 12 is extended in the −Y direction more than the communication path 123, an opening of the collection path 124 on the surface 120b of the communication plate 120 facing the −Z direction and a portion of the pressure chamber 12 extended in the −Y direction more than the communication path 123 communicate with each other in the Z-axis direction. In this manner, by directly connecting the collection path 124 to the pressure chamber 12, even in a case where air bubbles enter the pressure chamber 12 from the communication path 123, it is possible to discharge the air bubbles in the pressure chamber 12 to the collection path 124. Incidentally, if the collection path 124 is connected only to the communication path 123 without being directly connected to the pressure chamber 12, it is necessary for the air bubbles that have entered the pressure chamber 12 to move to the collection path 124 via the communication path 123, which is difficult.

The nozzle plate 20 is a plate-shaped member bonded to the surface 120a of the communication plate 120 opposite to the pressure chamber substrate 10, that is, facing the +Z direction. In the nozzle plate 20, a plurality of nozzles 21 are formed, each of which communicates with each of the pressure chambers 12 via each of the communication paths 123. In the present embodiment, the plurality of nozzles 21 are arranged side by side in a row in the X-axis direction. As such a nozzle plate 20, a silicon substrate or an SOI substrate is preferably used. The material of the nozzle plate 20 is not limited to this, and a glass substrate, any kind of ceramic substrates, a metal substrate such as a stainless steel substrate, an organic material such as a polyimide resin, or the like may be used. In the present embodiment, a surface facing the +Z direction on which the nozzles 21 of the nozzle plate 20 are open is referred to as a nozzle surface 20a.

A first piezoelectric element 301, a second piezoelectric element 302, and a third piezoelectric element 303 are stacked on the surface of the pressure chamber substrate 10 facing the −Z direction via the first diaphragm 51, the second diaphragm 52, and the third diaphragm 53, respectively.

In the present embodiment, the first diaphragm 51, the second diaphragm 52, and the third diaphragm 53 have the same thickness, the same material, and the same stacked structure. Therefore, hereinafter, in a case where the first diaphragm 51, the second diaphragm 52, and the third diaphragm 53 are not distinguished, they are referred to as the diaphragm 50. Of course, the first diaphragm 51, the second diaphragm 52, and the third diaphragm 53 may have different stacked structures such as film thicknesses and materials.

The first diaphragm 51 includes, for example, an elastic film 50a made of silicon oxide and an insulating film 50b made of zirconium oxide provided on a surface of the elastic film 50a facing the −Z direction. In the present embodiment, the second diaphragm 52 and the third diaphragm 53 are provided to be continuous with the first diaphragm 51. That is, the second diaphragm 52 and the third diaphragm 53 include the elastic film 50a and the insulating film 50b. In the diaphragm 50 stacked on the surface of the pressure chamber substrate 10 facing the −Z direction, among openings of the surface of the pressure chamber substrate 10 facing the −Z direction, a portion covering the opening of the pressure chamber 12 is referred to as the first diaphragm 51, a portion covering the opening of the detection chamber 15 is referred to as the second diaphragm 52, and a portion covering the opening of the absorption chamber 14 is referred to as the third diaphragm 53. Recessed portions as the pressure chambers 12, the ink supply paths 13, the absorption chamber 14, and the detection chambers 15 may be formed by etching the surface of the pressure chamber substrate 10 facing the +Z direction in the −Z direction. In this case, since each of bottom surfaces of the recessed portions becomes the elastic film 50a, the pressure chamber substrate 10 and the elastic film 50a which is a part of the diaphragm 50 are integrally formed. In addition, the entire diaphragm 50 and the pressure chamber substrate 10 may be integrally formed.

Each of the first piezoelectric elements 301, the second piezoelectric elements 302, and the third piezoelectric element 303 includes electrodes on an upper surface facing the −Z direction and a lower surface facing the +Z direction of a piezoelectric body. When a voltage is applied between the upper and lower electrodes, the piezoelectric body interposed between the two electrodes is deformed by the electrostrictive effect, and on the other hand, when a force that deforms the piezoelectric body from the outside is applied, a voltage is generated between the electrodes by the piezoelectric effect. In the present embodiment, the first piezoelectric element 301, the second piezoelectric element 302, and the third piezoelectric element 303 have roughly the same configuration, but the first piezoelectric element 301 is used as a piezoelectric element that generates vibration in the first diaphragm 51 by applying a voltage between the electrodes, and the second piezoelectric element 302 is used as a piezoelectric element that generates pressure by vibration being applied to the second diaphragm 52 from the outside, to detect the vibration. The third piezoelectric element 303 has the same configuration as the other piezoelectric elements, but is not electrically connected to the upper and lower electrodes, and is used as a mass for absorbing the pressure change of the ink in the absorption chamber 14.

First, the first piezoelectric element 301 will be described. The first piezoelectric element 301 includes a first lower electrode 61, a first piezoelectric layer 71, and a first upper electrode 81 which are sequentially stacked on the first diaphragm 51. Such a first piezoelectric element 301 is also referred to as a piezoelectric actuator, and refers to a portion including the first lower electrode 61, the first piezoelectric layer 71, and the first upper electrode 81. In the present embodiment, the first piezoelectric element 301 is formed for each pressure chamber 12. That is, a plurality of first piezoelectric elements 301 are arranged in parallel in the X-axis direction on the first diaphragm 51 of the pressure chamber substrate 10. The plurality of first piezoelectric elements 301 serve as driving elements that cause the pressure change in the ink in the pressure chambers 12. In general, any one of the electrodes of the first piezoelectric element 301 is configured as an individual electrode independent of the electrodes of the other first piezoelectric elements 301, and the other electrode is configured as a common electrode common to the plurality of first piezoelectric elements 301. In the present embodiment, the first lower electrode 61 constitutes an individual electrode, and the first upper electrode 81 constitutes a common electrode. Of course, the first lower electrode 61 may constitute the common electrode, and the first upper electrode 81 may constitute the individual electrode. The deformation of the first piezoelectric element 301 causes the first diaphragm 51 to undergo flexural deformation, and a pressure change is generated in the ink in the pressure chamber 12.

In addition, as shown in FIGS. 3 and 4, a first individual lead electrode 91 which is lead-out wiring is led out from the first lower electrode 61 of the first piezoelectric element 301. In addition, a first common lead electrode (not shown) which is lead-out wiring is led out from the first upper electrode 81. A flexible substrate 110 which is a wiring substrate having flexibility is connected to end portions of each of the first individual lead electrodes 91 and the first common lead electrode (not shown), the end portions being opposite to end portions connected to the first piezoelectric element 301. In other words, the flexible substrate 110 is electrically connected to the first piezoelectric elements 301. The flexible substrate 110 is electrically connected to a controller 4, and exchanges a signal that drives the first piezoelectric elements 301, detection signals corresponding to residual vibrations generated in the second piezoelectric elements 302, and the like with the controller 4 via a control circuit 111. That is, the control circuit 111 includes a plurality of switching elements that select whether or not to supply a drive signal for driving each of the first piezoelectric elements 301 to each of the first piezoelectric elements 301. That is, the flexible substrate 110 in the present embodiment is a chip on film (COF). Note that the flexible substrate 110 is not necessarily provided with the control circuit 111. That is, the flexible substrate 110 may be a flexible flat cable (FFC), flexible printed circuits (FPCs), or the like.

The third diaphragm 53 covers the opening corresponding to the absorption chamber 14 among the openings of the pressure chamber substrate 10 facing the −Z direction. The third diaphragm 53 is formed to be continuous with the first diaphragm 51 as described above. That is, the third diaphragm 53 includes the elastic film 50a and the insulating film 50b. The third diaphragm 53 is deformed by the pressure of the ink in the absorption chamber 14 and absorbs the pressure fluctuation of the ink in the absorption chamber 14.

In addition, the third piezoelectric element 303 is stacked on a surface of the third diaphragm 53 facing the −Z direction. The third piezoelectric element 303 is disposed at a position overlapping the absorption chamber 14 when viewed in the Z-axis direction. Similarly to the first piezoelectric element 301, the third piezoelectric element 303 includes a third lower electrode 63, a third piezoelectric layer 73, and a third upper electrode 83 which are sequentially stacked on the third diaphragm 53. Since the third lower electrode 63, the third piezoelectric layer 73, and the third upper electrode 83 are similar to the first lower electrode 61, the first piezoelectric layer 71, and the first upper electrode 81 of the first piezoelectric element 301, respectively in terms of electrode arrangement, structure, materials, and the like, a detailed description thereof will be omitted. The third piezoelectric element 303 is different from the first piezoelectric element 301 in that the third lower electrode 63 is provided continuously in the X-axis direction. That is, in the present embodiment, one third piezoelectric element 303 is provided for the absorption chamber 14. Of course, the third piezoelectric element 303 may be provided to be divided into a plurality with respect to one absorption chamber 14. Note that the third piezoelectric element 303 is not necessarily required, and the third piezoelectric element 303 need not be provided.

The second diaphragm 52 covers the openings corresponding to the detection chambers 15 among the openings of the pressure chamber substrate 10 facing the −Z direction. The second diaphragm 52 is formed to be continuous with the first diaphragm 51. That is, the second diaphragm 52 includes the elastic film 50a and the insulating film 50b. Of course, each layer of the second diaphragm 52 may be formed simultaneously with those of the first diaphragm 51, or may be formed individually. The second diaphragm 52 is deformable in accordance with the pressure fluctuation of the ink in the detection chamber 15. Each of a plurality of second diaphragms 52 individually fluctuates in correspondence with each of the plurality of detection chambers 15.

In addition, the second piezoelectric element 302 is stacked on the surface of the second diaphragm 52 facing the −Z direction. The second piezoelectric element 302 is disposed at a position overlapping the detection chamber 15 when viewed in the Z-axis direction. That is, similarly to the first piezoelectric element 301, the second piezoelectric element 302 includes a second lower electrode 62, a second piezoelectric layer 72, and a second upper electrode 82 which are sequentially stacked on the second diaphragm 52. In the present embodiment, the second piezoelectric element 302 is formed for each detection chamber 15. That is, a plurality of second piezoelectric elements 302 are arranged in parallel in the X-axis direction on the second diaphragm 52 of the pressure chamber substrate 10. The plurality of second piezoelectric elements 302 serve as detection elements that detect the pressure fluctuation in the detection chambers 15. In addition, each of the second lower electrodes 62 of each of the second piezoelectric elements 302 is divided for each detection chamber 15 and functions as an individual electrode of each second piezoelectric element 302, and the second upper electrode 82 is continuously provided over the plurality of detection chambers 15 and functions as a common electrode of the plurality of second piezoelectric elements 302. Since the second lower electrode 62, the second piezoelectric layer 72, and the second upper electrode 82 of the second piezoelectric element 302 are similar to the first lower electrode 61, the first piezoelectric layer 71, and the first upper electrode 81 of the first piezoelectric element 301, respectively in terms of electrode arrangement, structure, materials, and the like, a detailed description thereof will be omitted. Similarly to the first lower electrode 61 and the first upper electrode 81 of the first piezoelectric element 301, the second lower electrode 62 and the second upper electrode 82 of the second piezoelectric element 302 are connected to the flexible substrate 110 via a second individual lead electrode 92 and a second common lead electrode (not shown), respectively. The second piezoelectric elements 302 are not necessarily required, and the second piezoelectric elements 302 need not be provided.

Here, when a pressure fluctuation is generated in the ink in the pressure chamber 12 by the first piezoelectric element 301 and ink droplets are ejected from the nozzle 21, the pressure fluctuation of the pressure chamber 12 remains for a predetermined period after the ink droplets are ejected. This is called a residual vibration. Since the pressure fluctuation of the ink in the pressure chamber 12 is also propagated to the ink in the detection chamber 15 via the collection path 124, the second piezoelectric element 302 detects the residual vibration of the detection chamber 15. That is, the second piezoelectric element 302 detects the residual vibration as a voltage signal by the electromotive voltage generated when the residual vibration of the ink in the detection chamber 15 fluctuates. Then, the control circuit 111 extracts the state of the residual vibration, for example, information such as the cycle and the amplitude of the residual vibration from the voltage signal generated in the second piezoelectric element 302, and outputs the information to the controller 4. The controller 4 detects an ejection failure of the ink droplets from the information such as the cycle and the amplitude of the residual vibration.

The protective substrate 30 having substantially the same size as the pressure chamber substrate 10 is bonded to the surface of the pressure chamber substrate 10 facing in the −Z direction. The protective substrate 30 includes accommodation portions 31A to 31C which are spaces for protecting the first piezoelectric elements 301, the second piezoelectric elements 302, and the third piezoelectric element 303, respectively. The accommodation portions 31A to 31C each have a recessed shape which is open on a surface of the protective substrate 30 facing the +Z direction. The plurality of first piezoelectric elements 301 are accommodated in the accommodation portion 31A. The plurality of second piezoelectric elements 302 are accommodated in the accommodation portion 31B. The single third piezoelectric element 303 is accommodated in the accommodation portion 31C. In addition, the protective substrate 30 has an opening portion 32 passing in the Z-axis direction between two accommodation portions 31A and 31B arranged side by side in the Y-axis direction. Each end portion of the first individual lead electrodes 91 and the first common lead electrode (not shown) led out from each electrode of the first piezoelectric elements 301, and the second individual lead electrodes 92 and the second common lead electrode (not shown) led out from each electrode of the second piezoelectric elements 302 is extended so as to be exposed in the opening portion 32. The first individual lead electrodes 91, the first common lead electrode, the second individual lead electrodes 92, and the second common lead electrode are electrically connected to the flexible substrate 110 in the opening portion 32. Such an opening portion 32 is disposed at a position overlapping the collection paths 124 when viewed in the Z-axis direction. That is, the flexible substrate 110 is bonded to each of the lead electrodes 91 and 92 and the like led out from the first piezoelectric elements 301 and the second piezoelectric elements 302 on the diaphragm 50 at a position which is in the −Z direction of the diaphragm 50 and overlaps the collection paths 124 when viewed in the −Z direction. That is, the flexible substrate 110 is connected onto the diaphragm 50 between the pressure chambers 12 and the detection chambers 15 in the Y-axis direction. That is, the flexible substrate 110 is connected onto the diaphragm 50 at a position overlapping a portion of the pressure chamber substrate 10 where the flow paths are not provided when viewed in the −Z direction. Here, since the diaphragm 50 applies pressure to the pressure chambers 12 and is deformed by the pressure fluctuation in the detection chambers 15, the diaphragm 50 is relatively thin and is easily deformed. For this reason, if the collection paths are provided in, for example, the pressure chamber substrate 10, the diaphragm 50 on the collection paths would be thin, and the flexible substrate 110 would be connected onto the diaphragm 50 on the collection paths, so that the diaphragm 50 would be easily broken by the stress when the flexible substrate 110 is connected. In the present embodiment, the collection paths 124 are provided in the communication plate 120, and the flexible substrate 110 is connected onto the diaphragm 50 at a position overlapping a portion where the flow paths of the pressure chamber substrate 10 are not provided when viewed in the −Z direction. For this reason, the region of the diaphragm 50 to which the flexible substrate 110 is connected is supported by the pressure chamber substrate 10. Therefore, it is possible to suppress the occurrence of a crack in the diaphragm 50 due to the stress when the flexible substrate 110 is connected onto the diaphragm 50.

As such a protective substrate 30, a silicon substrate or an SOI substrate is preferably used. The material of the protective substrate 30 is not limited to this, and a glass substrate, any kind of ceramic substrates, a metal substrate such as a stainless steel substrate, or the like may be used.

In addition, the protective substrate 30 includes a flow path 33A constituting a portion of the supply-side common liquid chamber 100A, and a flow path 33B constituting a portion of the discharge-side common liquid chamber 100B. The flow paths 33A and 33B are provided to pass through the protective substrate 30 in the Z-axis direction. The flow path 33A is located in the +Y direction of the accommodation portion 31C, and the flow path 33B is located in the −Y direction of the accommodation portion 31B.

The case 40 is located in the −Z direction of the protective substrate 30. The case 40 includes a flow path 41A constituting a part of the supply-side common liquid chamber 100A, and a flow path 41B constituting a part of the discharge-side common liquid chamber 100B. The flow path 41A is disposed at a position overlapping the flow path 33A of the protective substrate 30 when viewed in the Z-axis direction, and communicates with the flow path 33A. The flow path 41B is disposed at a position overlapping the flow path 33B of the protective substrate 30 when viewed in the Z-axis direction, and communicates with the flow path 33B. The flow paths 41A and 41B each have a recessed shape which is open on a surface of the case 40 facing the +Z direction. In addition, the case 40 includes a supply port 42 for supplying the ink to the flow path 41A and a discharge port 43 for discharging the ink in the flow path 41B to the outside. As such a case 40, metal or resin is used, for example.

The supply-side common liquid chamber 100A of the present embodiment is configured with the flow path 41A provided in the case 40, the flow path 33A provided in the protective substrate 30, the flow path 16A provided in the pressure chamber substrate 10, and the flow path 121A provided in the communication plate 120. The discharge-side common liquid chamber 100B is configured with the flow path 41B provided in the case 40, the flow path 33B provided in the protective substrate 30, the flow path 16B provided in the pressure chamber substrate 10, and the flow path 121B provided in the communication plate 120. The ink from a liquid storage portion (not shown) is supplied to the supply-side common liquid chamber 100A via the supply port 42. The ink in the supply-side common liquid chamber 100A flows to the discharge-side common liquid chamber 100B via the absorption chamber 14, the ink supply paths 13, the pressure chambers 12, the collection paths 124, and the detection chambers 15. Then, the ink in the discharge-side common liquid chamber 100B is discharged to the outside of the liquid ejecting head H from the discharge port 43.

The case 40 also has a through hole 44 communicating with the opening portion 32 of the protective substrate 30. The through hole 44 is provided to pass through the case 40 in the Z-axis direction. Then, the flexible substrate 110 connected to the first piezoelectric elements 301 and the second piezoelectric elements 302 on the diaphragm 50 of the pressure chamber substrate 10 is led out toward a surface of the case 40 facing the −Z direction through the opening portion 32 of the protective substrate 30 and the through hole 44 of the case 40.

In addition, a supply-side compliance substrate 130A and a discharge-side compliance substrate 130B are provided on the surface 120a facing the +Z direction on which the flow paths 121A and 121B of the communication plate 120 are open. In the present embodiment, the supply-side compliance substrate 130A and the discharge-side compliance substrate 130B have the same configuration. Therefore, the supply-side compliance substrate 130A will be described below, but the discharge-side compliance substrate 130B has a similar configuration.

In the present embodiment, the compliance substrate 130A includes a sealing film 131 consisting of a flexible thin film and a fixing substrate 132 consisting of a hard material such as metal. A region of the fixing substrate 132 opposite to the common liquid chamber 100A is an opening portion 133 which is completely removed in the thickness direction, and a surface of the common liquid chamber 100A in the +Z direction is a compliance portion 134 defined only by the sealing film 131. Since such a compliance portion 134 is deformed, it is possible to absorb the pressure fluctuation of the ink in the common liquid chamber 100A and to suppress the occurrence of the variation in the ejection characteristics such as the flying speed and the weight of the ink droplets ejected from the nozzles 21.

As described above, in the liquid ejecting head H of the present embodiment, since the collection path 124 is connected to the communication path 123 which is further in the +Z direction than the pressure chamber 12, it is possible to discharge the air bubbles to the collection path 124 before the air bubbles which have been drawn from the nozzle 21 and entered the communication path 123 or the air bubbles which have entered the communication path 123 from the ink supply path 13 rise to the pressure chamber 12 due to the buoyancy.

Furthermore, since the collection path 124 is adjacent to the first surface 123a of the communication path 123 and is connected to the communication path 123, air bubbles easily flow into the collection path 124 from the communication path 123. Therefore, it is possible to improve the air-bubble discharging performance by the collection path 124. Incidentally, for example, if the collection path 124 is provided to communicate with only the pressure chamber 12, the air bubbles in the communication path 123 need to move toward the pressure chamber 12 located in the −Z direction and then move to the collection path 124 in the +Z direction. The movement of the air bubbles in the communication path 123 in the −Z direction toward the pressure chamber 12 is easily performed by the buoyancy of the air bubbles, but the movement of the air bubbles in the pressure chamber 12 in the +Z direction toward the collection path 124 has to be performed against the buoyancy of the air bubbles, and the movement is difficult. Therefore, the air bubbles are likely to remain in the pressure chamber 12, and the pressure fluctuation of the ink in the pressure chamber 12 is absorbed by the air bubbles, so that the ejection failure of the ink droplets is likely to occur. In the present embodiment, since the air bubbles in the communication path 123 are likely to directly flow into the collection path 124 without moving in the −Z direction toward the pressure chamber 12, the air bubbles are unlikely to remain in the pressure chamber 12, and it is possible to suppress the ejection failure of the ink droplets due to the air bubbles in the pressure chamber 12.

In addition, in the present embodiment, the collection path 124 is defined by a recessed portion, the recessed portion being recessed in the +Z direction from the surface 120b of the communication plate 120 facing the −Z direction and being connected to the communication path 123. That is, the collection paths 124 are not defined by the nozzle plate 20. For this reason, it is possible to improve the strength of the communication plate 120 with respect to an impact due to the print medium colliding with the nozzle surface 20a of the liquid ejecting head H or the like, and it is possible to suppress destruction of the communication plate 120. In addition, since the collection paths 124 are not defined by the nozzle plate 20, it is possible to provide the nozzle plate 20 with a minimum size, and to suppress an increase in size of the nozzle plate 20.

In addition, since the second surface 123b which defines a side surface of the communication path 123 in the +Y direction is formed as an inclined surface which is inclined in the +Z direction while extending toward the −Y direction, the air bubbles drawn into the communication path 123 from the nozzle 21 or the liquid supplied to the communication path 123 from the pressure chamber 12 are unlikely to stagnate, and the air bubbles are unlikely to remain in the communication path 123.

In the present embodiment, the +Z direction is an example of an “ejection direction”, the −Y direction is an example of a “first direction”, the −Z direction is an example of a “second direction”, and the +X direction is an example of a “third direction”. In addition, the pressure chamber substrate 10 is an example of a “first member”, the communication plate 120 is an example of a “second member”, and a combination of the pressure chamber substrate 10 and the communication plate 120 is an example of a “flow path substrate”.

### Second Embodiment

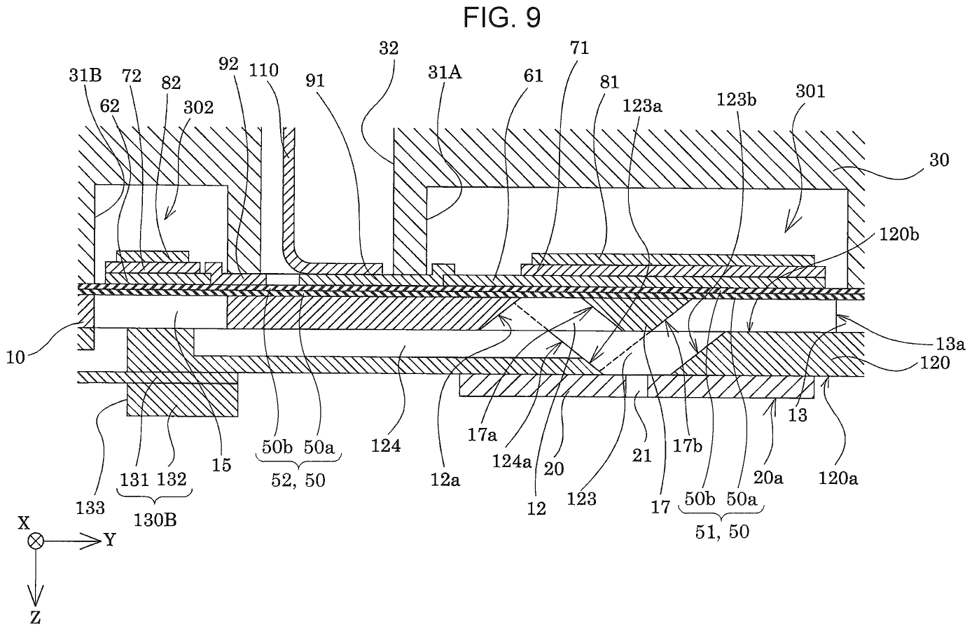

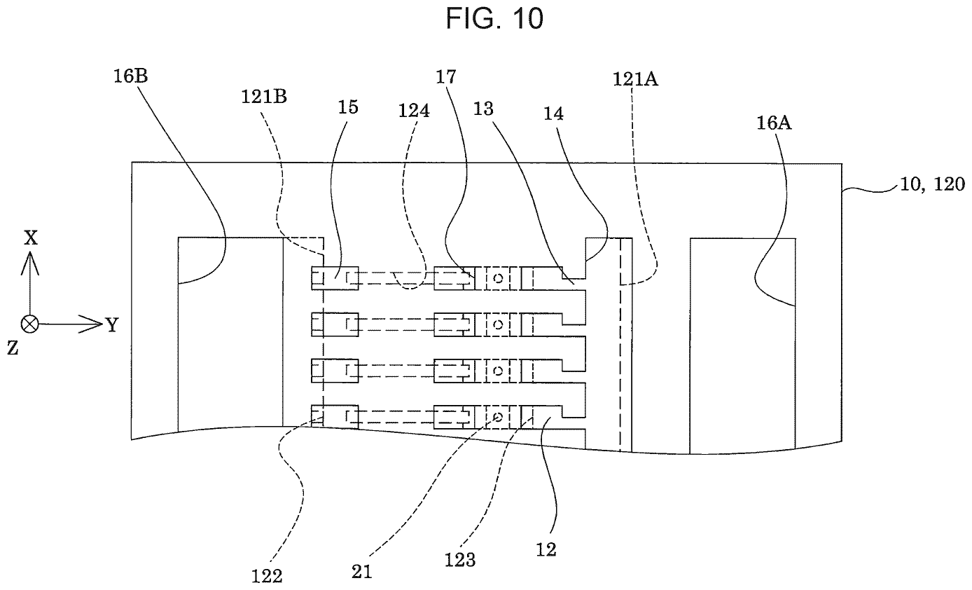

FIG. 9 is a sectional view of a main portion of a liquid ejecting head according to a second embodiment of the present disclosure. FIG. 10 is a plan view of a pressure chamber substrate 10 and a communication plate 120 as viewed in the +Z direction. The same reference numerals are used for the same members as those in the above-described embodiment, and repetitive descriptions will be omitted. In FIG. 10, flow paths and nozzles 21 provided in the communication plate 120 are indicated by dotted lines.

As shown, a liquid ejecting head H includes protrusion portions 17 protruding from a diaphragm 5 0 toward the +Z direction. Each of the protrusion portions 17 overlaps each of the nozzles 21 in the −Z direction. That is, when viewed in the +Z direction, the protrusion portion 17 is disposed at a position overlapping the nozzle 21. Here, the protrusion portion 17 overlapping the nozzle 21 in the −Z direction means that at least a part of the nozzle 21 overlaps the protrusion portion 17. In the present embodiment, when viewed in the Z-axis direction, each and every one of the nozzles 21 overlaps each of the protrusion portions 17. In addition, in the present embodiment, each end surface of the protrusion portions 17 in the +Z direction overlaps each and every one of the nozzles 21 when viewed in the Z-axis direction. Of course, it is sufficient that the protrusion portion 17 overlaps at least a part of the nozzle 21 when viewed in the −Z direction.

In the present embodiment, such a protrusion portion 17 is formed of a part of the pressure chamber substrate 10. That is, the height of the protrusion portion 17 from the diaphragm 50 in the +Z direction is the same as the thickness of the pressure chamber substrate 10. For this reason, at least a part of the connection port 124a through which the collection path 124 and the communication path 123 are connected to each other is located further in the +Z direction than an end portion of the protrusion portion 17 in the +Z direction

In addition, both sides of the protrusion portion 17 in the Y-axis direction are defined by a fourth surface 17a and a fifth surface 17b. Here, the fourth surface 17a defines a side surface of the protrusion portion 17 in the −Y direction, and the fifth surface 17b defines a side surface of the protrusion portion 17 in the +Y direction.

The fourth surface 17a is an inclined surface which is inclined in the −Z direction while extending toward the −Y direction. The fourth surface 17a is parallel to the first surface 123a. Here, “two surfaces are parallel” in the present specification means that the angle formed by the two surfaces is 5 degrees or less.

The fifth surface 17b is an inclined surface which is inclined in the +Z direction while extending toward the +Y direction. That is, in the cross section shown in FIG. 9, the protrusion portion 17 has a trapezoidal shape with a narrow end portion in the +Z direction. The first surface 123a is located on an extension line of the fifth surface 17b when viewed in the X-axis direction. Here, the first surface 123a being located on the extension line of the fifth surface 17b means that a virtual plane extending the fifth surface 17b in the +Z direction and the −Y direction along the fifth surface 17b intersects with the first surface 123a. In FIG. 9, the virtual plane is indicated by a dotted line.

By providing the protrusion portion 17 in this manner, the sectional area in the +Z direction of the flow path between the protrusion portion 17 and the nozzle 21, that is, the sectional area crossing in the −Y direction is reduced. For this reason, the flow velocity of the ink between the protrusion portion 17 and the nozzle 21 increases, the air bubbles which have entered between the protrusion portion 17 and the nozzle 21 easily flow toward the −Y direction, and the air bubbles in the communication path 123 easily flow into the collection path 124 before rising to the pressure chamber 12. Therefore, the air bubbles in the communication path 123 can be easily discharged through the collection path 124, and the air-bubble discharging performance can be improved.

In addition, since the flow velocity of the ink flowing through the flow path between the protrusion portion 17 and the nozzle 21 increases, it is possible to suppress the thickening of the ink in the vicinity of the nozzle 21 due to the evaporation of moisture contained in the ink from the nozzle 21.

In addition, in the present embodiment, at least a part of the connection port 124a through which the collection path 124 and the communication path 123 are connected to each other is located further in the +Z direction than the end portion of the protrusion portion 17 in the +Z direction, and thus the ink of which the flow velocity between the protrusion portion 17 and the nozzle 21 is increased by the protrusion portion 17 easily flows into the collection path 124. Therefore, the air bubbles in the communication path 123 can easily flow into the collection path 124.

In addition, in the present embodiment, since the fourth surface 17a of the protrusion portion 17 is parallel to the first surface 123a, it is easy for the ink to flow along the first surface 123a and the fourth surface 17a, and it is possible to improve the air-bubble discharging performance.

In addition, in the present embodiment, since the first surface 123a is located on the extension line of the fifth surface 17b of the protrusion portion 17, the ink flowing along the fifth surface 17b collides with the first surface 123a, and easily flows toward the collection path 124 along the first surface 123a. Therefore, the air-bubble discharging performance can be improved.

In the present embodiment, the end portion of the pressure chamber 12 in the −Y direction is defined by a third surface 12a. The third surface 12a is formed of an inclined surface which is inclined in the +Z direction while extending toward the −Y direction. The third surface 12a is located on an extension line of the first surface 123a when viewed in the X-axis direction. Here, the third surface 12a being located on the extension line of the first surface 123a means that a virtual plane extending the first surface 123a in the −Z direction and the −Y direction along the first surface 123a intersects with the third surface 12a. In FIG. 9, the virtual plane is indicated by a dotted line. Since the third surface 12a is disposed on the extension line of the first surface 123a in this manner, in addition to the flow velocity of the ink being increased by the protrusion portion 17, the flow of the ink collides with the third surface 12a, and the ink easily flows to the collection path 124. For this reason, even if the air bubbles are not discharged from the communication path 123 to the collection path 124 and move into the pressure chamber 12, the air bubbles in the pressure chamber 12 are easily discharged to the collection path 124 by the flow of the ink along the first surface 123a and the third surface 12a.

In the present embodiment, the +Z direction is an example of an “ejection direction”, the −Y direction is an example of a “first direction”, the −Z direction is an example of a “second direction”, and the +X direction is an example of a “third direction”. In addition, the pressure chamber substrate 10 is an example of a “first member”, the communication plate 120 is an example of a “second member”, a combination of the pressure chamber substrate 10 and the communication plate 120 is an example of a “flow path substrate”, and the flexible substrate 110 is an example of a “wiring member”.

### Other Embodiments

Although each embodiment of the present disclosure has been described above, the basic configuration of the present disclosure is not limited to the above-described embodiments.

For example, in each of the embodiments described above, the first surface 123a is an inclined surface, but is not particularly limited thereto, and may be a curved surface such as a convex curved surface or a concave curved surface. Further, the first surface 123a may be a combination of an inclined surface and a curved surface. Similarly to the first surface 123a, each of the second surface 123b, the third surface 12a, the fourth surface 17a, and the fifth surface 17b may be a curved surface such as a convex curved surface or a concave curved surface, or may be a combination of an inclined surface and a curved surface.

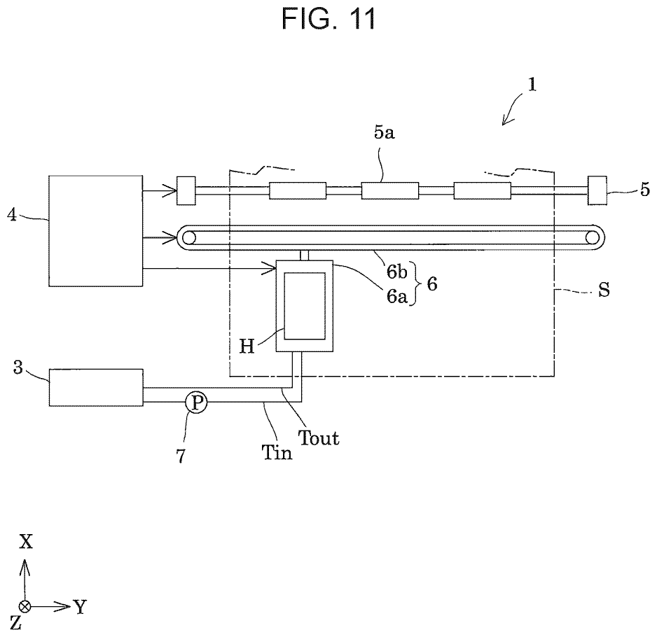

In addition, the liquid ejecting head H of each embodiment described above is mounted on a liquid ejecting apparatus 1. FIG. 11 is a view showing a schematic configuration of the liquid ejecting apparatus 1 according to an embodiment of the present disclosure.

As shown, the liquid ejecting apparatus 1 is a so-called serial printer which includes the liquid ejecting head H and performs printing by the ejection of a liquid (also referred to as ejecting a liquid) in the +Z direction from the liquid ejecting head H toward a medium S while transporting the medium S in the X-axis direction and reciprocating the liquid ejecting head H in the Y-axis direction. As the medium S, in addition to recording paper, any material such as a resin film or cloth can be used. In addition, the direction in which the liquid ejecting head H reciprocates is not limited to the Y-axis direction, and may be a direction inclined with respect to both the X-axis direction and the Y-axis direction.

The liquid ejecting apparatus 1 includes the liquid ejecting head H, a liquid storage portion 3, a controller 4, a transport mechanism 5 that sends the medium S, and a movement mechanism 6.

The liquid ejecting head H ejects a liquid supplied from the liquid storage portion 3 in the form of liquid droplets in the +Z direction.

The liquid storage portion 3 stores the liquid ejected from the liquid ejecting head H. Examples of the liquid storage portion 3 include, for example, a cartridge attachable to and detachable from the liquid ejecting apparatus 1, a bag-shaped ink pack made of a flexible film, and an ink tank that can be refilled with ink.

A supply tube Tin and a discharge tube Tout are connected to the liquid storage portion 3.

The supply tube Tin is a tube that supplies, to the liquid ejecting head H, the ink of the liquid storage portion 3 caused to have a predetermined pressure by a pump 7. The discharge tube Tout is a tube that collects the ink collected from the liquid ejecting head H to the liquid storage portion 3.

Although not particularly shown, the liquid storage portion 3 may be divided into a main tank and a sub-tank. The sub-tank may be connected to the liquid ejecting head H, and may be configured to be refilled with the liquid consumed by ejecting the liquid droplets from the liquid ejecting head H, from the main tank.

The controller 4 includes, for example, a control device such as a central processing unit (CPU) or a field programmable gate array (FPGA), and a storage device such as a semiconductor memory. The controller 4 also includes a power supply device that supplies, to each element of the liquid ejecting apparatus 1, power supplied from an external power supply such as a commercial power supply. The controller 4 is electrically connected to the liquid ejecting head H via the flexible substrate 110 described above. The controller 4 comprehensively controls each element of the liquid ejecting apparatus 1 by the control device executing a program stored in the storage device.

The transport mechanism 5 transports the medium S in the X-axis direction and includes, for example, transport rollers 5a rotated by a transport motor that is driven by the control of the controller 4.

The movement mechanism 6 is a mechanism for reciprocating the liquid ejecting head H in the Y-axis direction, and includes a holding body 6a that holds the liquid ejecting head H and a transport belt 6b which is an endless belt installed in the Y-axis direction. The controller 4 rotates the transport belt 6b by controlling the drive of the transport motor (not shown) to reciprocate the liquid ejecting head H in the Y-axis direction together with the holding body 6a fixed to the transport belt 6b. The liquid storage portion 3 can also be mounted on the holding body 6a together with the liquid ejecting head H. The holding body 6a holds one liquid ejecting head H, but the holding body 6a may hold two or more liquid ejecting heads H.

The liquid ejecting head H, under the control of the controller 4, performs an ejecting operation of ejecting the ink supplied from the liquid storage portion 3 in the form of ink droplets from each of the plurality of nozzles 21 (see FIG. 4) in the +Z direction. The controller 4 functions as an ejection controller that controls the ejection of the ink by the liquid ejecting head H. The ejecting operation performed by the liquid ejecting head H is performed in parallel with the transportation of the medium S in the X-axis direction that is performed by the transport mechanism 5 and the reciprocation of the liquid ejecting head H in the Y-axis direction that is caused by the movement mechanism 6, so that so-called printing, in which ink is applied to the medium S, is performed.

Note that, in the example shown in FIG. 11, the liquid ejecting apparatus 1 in which the liquid ejecting head H is mounted on the holding body 6a and moves in the main scanning direction is exemplified, but the configuration is not particularly limited thereto, and, for example, the present disclosure can also be applied even to a so-called line printer in which the liquid ejecting head H is fixed and only the medium S is moved in a sub-scanning direction to perform printing.

In addition, the present disclosure is widely intended for liquid ejection heads and liquid ejection apparatuses in general, and can of course also be applied to liquid ejection heads and liquid ejection apparatuses which eject liquid other than ink. Examples of other liquid ejection heads include, for example, various recording heads used in image recording apparatuses such as printers, color material ejection heads used in the manufacture of color filters for liquid crystal displays and the like, electrode material ejection heads used in the formation of electrodes for organic EL displays, field emission displays (FEDs) and the like, and bio-organic substance ejection heads used in the manufacture of biochips, and the like, and the present disclosure can also be applied to liquid ejection apparatuses including such liquid ejection heads.

### Supplementary Notes

From the forms described above, for example, the following configurations can be understood.

According to Aspect 1 which is a preferred aspect, there is provided a liquid ejecting head including a nozzle that ejects a liquid in an ejection direction, a pressure chamber that communicates with the nozzle and applies a pressure to the liquid, a communication path connected to the pressure chamber in the ejection direction and connected to the nozzle, a supply path that communicates with the pressure chamber and supplies the liquid to the pressure chamber, and a collection path that communicates with the communication path and collects the liquid from the communication path, wherein the supply path, the pressure chamber and the communication path, and the collection path are, in plan view as viewed in the ejection direction, arranged in this order in a first direction, the communication path is defined by a first surface disposed between the nozzle and the collection path, the first surface being an inclined surface or a curved surface that extends in a second direction opposite to the ejection direction while extending toward the first direction, and the collection path is connected to the communication path so as to be adjacent to the first surface. According to this configuration, since the collection path is connected to the communication path which is further in the ejection direction than the pressure chamber, it is possible to discharge the air bubbles which have been drawn in from the nozzle and are present in the communication path to the collection path before the air bubbles rise to the pressure chamber due to the buoyancy, and it is possible to improve air-bubble discharging performance. In addition, since the collection path is connected adjacent to the first surface of the communication path, it is easy for the air bubbles to flow into the collection path from the communication path, and it is possible to improve air-bubble discharging performance.

In Aspect 2 which is a specific example of Aspect 1, the liquid ejecting head further includes a nozzle plate provided with the nozzle, and a flow path substrate provided with the pressure chamber, the communication path, the supply path, and the collection path, the flow path substrate including a first member and a second member stacked on the first member in the ejection direction, the pressure chamber is provided in the first member, the second member includes a first through hole passing from a surface facing the second direction to a surface facing the ejection direction, and a recessed portion that is recessed in the ejection direction from the surface facing in the second direction, the recessed portion being connected to the first through hole, the communication path is defined by the first through hole, and the collection path is defined by the recessed portion.

In Aspect 3 which is a specific example of Aspect 1, the collection path extends in a direction perpendicular to the ejection direction from a connection port through which the collection path is connected to the communication path.

In Aspect 4 which is a specific example of Aspect 1, when a direction intersecting with the ejection direction and the first direction is defined as a third direction, a width of a connection port through which the collection path is connected to the communication path in the third direction is smaller than a width of the communication path in the third direction. According to this configuration, since the flow path sectional area of the collection path can be made relatively small, the flow velocity of the liquid flowing in the collection path can be improved, and the air-bubble discharging performance in the collection path can be improved.

In Aspect 5 which is a specific example of Aspect 2, the liquid ejecting head further includes a protrusion portion protruding in the ejection direction from a diaphragm that defines the pressure chamber, the protrusion portion overlapping the nozzle in the second direction. According to this configuration, by providing the protrusion portion, it is possible to reduce the sectional area of the flow path between the protrusion portion and the nozzle, which crosses the first direction, to improve the flow velocity of the liquid passing between the protrusion portion and the nozzle, and to easily cause the air bubbles in this portion to flow in the first direction. For this reason, the air bubbles in the communication path easily flow into the collection path before the air bubbles rise to the pressure chamber due to the buoyancy, and it is possible to improve the air-bubble discharging performance. In addition, since it is possible to improve the flow velocity of the flow path between the protrusion portion and the nozzle, it is possible to collect the liquid which is thickened due to the evaporation of moisture from the nozzle and to suppress the thickening of the liquid.

In Aspect 6 which is a specific example of Aspect 5, at least a part of a connection port through which the collection path and the communication path are connected to each other is located further in the ejection direction than an end portion of the protrusion portion in the ejection direction. According to this configuration, the liquid flowing between the protrusion portion and the nozzle easily flows into the collection path, and the air-bubble discharging performance can be further improved.

In Aspect 7 which is a specific example of Aspect 5, the protrusion portion includes a fourth surface, the fourth surface being a side surface in the first direction and extending in the second direction while extending toward the first direction, and the fourth surface is parallel to the first surface. According to this configuration, the liquid can easily flow between the fourth surface and the first surface, and the liquid flowing between the first surface and the fourth surface can easily flow into the collection path. Therefore, the air-bubble discharging performance can be improved.

In Aspect 8 which is a specific example of Aspect 5, the protrusion portion includes a fifth surface, the fifth surface being a side surface in a direction opposite to the first direction and extending in the ejection direction while extending toward the first direction, and the first surface is located on an extension line of the fifth surface. According to this configuration, the liquid flowing along the fifth surface collides with the first surface and easily flows along the first surface, the liquid flowing along the first surface easily flows into the collection path, and thus it is possible to improve the air-bubble discharging performance.

In Aspect 9 which is a specific example of Aspect 5, the first member includes a second through hole passing from a surface facing the second direction to a surface facing the ejection direction, the pressure chamber is defined by the second through hole, an end portion of the second through hole in the first direction is defined by a third surface, the third surface being an inclined surface or a curved surface extending in the ejection direction while extending toward the first direction, and the third surface is located on an extension line of the first surface. According to this configuration, the liquid flowing along the first surface collides with the third surface and easily flows along the third surface, and the liquid easily flows into the collection path from the third surface. For this reason, even if the air bubbles are not discharged from the communication path to the collection path and move to the pressure chamber, the air bubbles in the pressure chamber are easily discharged to the collection path by the flow of the liquid along the third surface, and it is possible to improve the air-bubble discharging performance.

In Aspect 10 which is a specific example of Aspect 1, the liquid ejecting head further includes a second surface facing the first surface, the second surface being an inclined surface or a curved surface extending in the ejection direction while extending toward the first direction. According to this configuration, the air bubbles drawn into the communication path from the nozzle and the liquid supplied to the communication path from the pressure chamber are unlikely to stagnate, and the air bubbles are unlikely to remain in the communication path.

In Aspect 11 which is a specific example of Aspect 1, at least a part of a connection port through which the collection path is connected to the communication path is disposed further in the ejection direction than a connection port through which the supply path is connected to the pressure chamber. According to this configuration, since at least a part of the connection port of the collection path is disposed further in the ejection direction than the connection port through which the supply path is connected to the pressure chamber, it is difficult for the air bubbles to enter the supply path, it is easy to discharge the air bubbles to the collection path, and it is possible to improve the air-bubble discharging performance. In addition, since the liquid flows from the supply path toward the collection path in the direction including the component of the ejection direction, it is possible to regulate the movement of the air bubbles in the direction including the component of the second direction due to the buoyancy.

In Aspect 12, which is a specific example of Aspect 2, the collection path is not defined by the nozzle plate. According to this configuration, since the collection path is formed without being open on the surface of the second member facing the ejection direction, it is possible to improve the strength of the second member and to suppress the breakage of the second member.

In Aspect 13 which is a specific example of Aspect 2, the liquid ejecting head further includes a diaphragm that is stacked on the flow path substrate in the second direction and defines the pressure chamber, a piezoelectric element that vibrates the diaphragm to cause a pressure fluctuation in the pressure chamber, and a wiring member electrically connected to the piezoelectric element, and the wiring member is bonded to a position overlapping the collection path when viewed in the second direction, the position being in the second direction with respect to the diaphragm. According to this configuration, even when the diaphragm is relatively thin and is easily deformed, it is possible to suppress breakage of the diaphragm due to the stress when the wiring member is bonded.

In Aspect 14 which is a specific example of Aspect 1, the pressure chamber and the collection path overlap each other when viewed in the ejection direction, and the collection path is connected to the pressure chamber in a region overlapping the pressure chamber. According to this configuration, since it is possible to discharge the air bubbles in the pressure chamber to the collection path without passing through the communication path, it is possible to improve the air-bubble discharging performance.

According to Aspect 15 which is a preferred aspect, there is provided a liquid ejecting apparatus including the liquid ejecting head according to any of the above-described aspects, and a liquid storage portion that supplies a liquid to the liquid ejecting head. According to this configuration, it is possible to realize a liquid ejecting apparatus with improved air-bubble discharging performance.

What is claimed is:

1. A liquid ejecting head comprising:
a nozzle that ejects a liquid in an ejection direction;
a pressure chamber that communicates with the nozzle and applies a pressure to the liquid;
a communication path connected to the pressure chamber in the ejection direction and connected to the nozzle;
a supply path that communicates with the pressure chamber and supplies the liquid to the pressure chamber; and
a collection path that communicates with the communication path and collects the liquid from the communication path,
wherein the supply path, the pressure chamber and the communication path, and the collection path are, in plan view as viewed in the ejection direction, arranged in this order in a first direction,
the communication path is defined by a first surface disposed between the nozzle and the collection path, the first surface being an inclined surface or a curved surface that extends in a second direction opposite to the ejection direction while extending toward the first direction, and
the collection path is connected to the communication path so as to be adjacent to the first surface.

2. The liquid ejecting head according to claim 1, further comprising:
a nozzle plate provided with the nozzle; and
a flow path substrate provided with the pressure chamber, the communication path, the supply path, and the collection path, the flow path substrate including a first member and a second member stacked on the first member in the ejection direction,
wherein the pressure chamber is provided in the first member,
the second member includes
a first through hole passing from a surface facing the second direction to a surface facing the ejection direction, and
a recessed portion that is recessed in the ejection direction from the surface facing in the second direction, the recessed portion being connected to the first through hole,
the communication path is defined by the first through hole, and
the collection path is defined by the recessed portion.

3. The liquid ejecting head according to claim 1, wherein the collection path extends in a direction perpendicular to the ejection direction from a connection port through which the collection path is connected to the communication path.

4. The liquid ejecting head according to claim 1, wherein when a direction intersecting with the ejection direction and the first direction is defined as a third direction, a width of a connection port through which the collection path is connected to the communication path in the third direction is smaller than a width of the communication path in the third direction.

5. The liquid ejecting head according to claim 2, further comprising a protrusion portion protruding in the ejection direction from a diaphragm that defines the pressure chamber, the protrusion portion overlapping the nozzle in the second direction.

6. The liquid ejecting head according to claim 5, wherein at least a part of a connection port through which the collection path and the communication path are connected to each other is located further in the ejection direction than an end portion of the protrusion portion in the ejection direction.

7. The liquid ejecting head according to claim 5, wherein the protrusion portion includes a fourth surface, the fourth surface being a side surface in the first direction and extending in the second direction while extending toward the first direction, and
the fourth surface is parallel to the first surface.

8. The liquid ejecting head according to claim 5, wherein the protrusion portion includes a fifth surface, the fifth surface being a side surface in a direction opposite to the first direction and extending in the ejection direction while extending toward the first direction, and
the first surface is located on an extension line of the fifth surface.

9. The liquid ejecting head according to claim 5, wherein the first member includes a second through hole passing from a surface facing the second direction to a surface facing the ejection direction,
the pressure chamber is defined by the second through hole,
an end portion of the second through hole in the first direction is defined by a third surface, the third surface being an inclined surface or a curved surface extending in the ejection direction while extending toward the first direction, and the third surface is located on an extension line of the first surface.

10. The liquid ejecting head according to claim 1, further comprising a second surface facing the first surface, the second surface being an inclined surface or a curved surface extending in the ejection direction while extending toward the first direction.

11. The liquid ejecting head according to claim 1, wherein at least a part of a connection port through which the collection path is connected to the communication path is disposed further in the ejection direction than a connection port through which the supply path is connected to the pressure chamber.

12. The liquid ejecting head according to claim 2, wherein the collection path is not defined by the nozzle plate.

13. The liquid ejecting head according to claim 2, further comprising:
a diaphragm that is stacked on the flow path substrate in the second direction and defines the pressure chamber;
a piezoelectric element that vibrates the diaphragm to cause a pressure fluctuation in the pressure chamber; and
a wiring member electrically connected to the piezoelectric element,
wherein the wiring member is bonded to a position overlapping the collection path when viewed in the second direction, the position being in the second direction with respect to the diaphragm.

14. The liquid ejecting head according to claim 1, wherein the pressure chamber and the collection path overlap each other when viewed in the ejection direction, and the collection path is connected to the pressure chamber in a region overlapping the pressure chamber.

15. A liquid ejecting apparatus comprising the liquid ejecting head according to claim 1, and a liquid storage portion that supplies a liquid to the liquid ejecting head.
